(19) United States
(12) Patent Application Publication
(10) Pub. No.: US 2004/0086349 A1
(43) Pub. Date: May 6, 2004

(54) Spark plug tap

(76) Inventor: John Wesley Branum SR., Eustis, FL (US)

Correspondence Address: John Wesley Branum Sr, 1316 S Grove Street, Eustis, FL, 32726, US

(21) Appl. No.: 10/092,688

(22) Filed: Oct. 31, 2002

(51) Int. Cl. B23B 51/00

(52) U.S. Cl. 408/222; 470/198

(57) ABSTRACT

The concept of my idea is a tool used in conjunction with a ratchet wrench that would re-thread a hole into which a spark plug was inserted or other holes with in which the threads are cross-threaded. It can be used in engine cylinder heads on both styles of engines, works well with over head cam engines. Produced from tool-grade steel, measuring 5 inches long and vary in diameter (½ and ⅜ inch.) ⅜-inch diameter found at the top of this tool would allow for the attachment of a ⅜-inch drive shaft of a ratchet wrench. The bottom of the shaft would feature threads that allow internal threads to align correctly. A ratchet wrench would be cranked to create the turning motion needed to cut the threads. This tool provides convenience, durability, and efficiency. The professional auto mechanics and the do-it-yourselfer can use it.

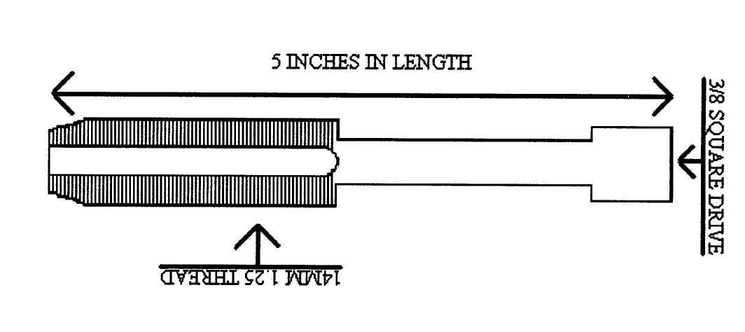

My invention was designed for a 4.6 Triton Motor and easier use.

The following is a description of my design:

14 mm 1.25 thread

⅜ square drive for ratchet for convenience.

5 inches long

Designed for 4.6 spark plug hole re-threader

Will work on all 14 mm 1.25 thread spark plug holes

Reason for design is tired of tap falling in hole

Holder would not hold

Used it for over one year

Works excellent for what it was designed for and other uses as well.

Here are the distinctive features of my product idea and the need it will fulfill. The concept of my idea is a tool used in conjunction with a ratchet wrench that would rethread a hole into which a spark plug was inserted or other holes with in which the threads are cross-threaded. Can be used in engine cylinder heads on both styles of engines, works well with over head cam engines. Produced from tool-grade steel, the cylindrical tap would measure 5 inches long and would vary in diameter between ½ and ⅜ inch. The ⅜-inch diameter found at the top of this tool would allow for the attachment of a ⅜-inch drive shaft of a ratchet wrench. The bottom of the shaft would feature threads that allow internal threads to be cut into a hole. During use, a ratchet wrench would be cranked to create the turning motion needed to cut the threads. I believe it would fulfill the need for a tool that can cut threads into a hole, especially in hard to reach areas. The appealing features make this tool an easy tool to work with. This tool provides convenience, durability and time saving efficiency. This tool will not fall apart while being used. This tool can correct the alignment of threads within a hole. The professional auto mechanics as well as the automotive do-it-yourselfers can use this tool.

I John Wesley Branum Sr. do claim the following:

1. that my device can be a sparkplug tap hole re-threader.

2. That it can come in different sizes ¼-¾ inch drive.

3. That it can be used in all different types of businesses from automotive to household items.

4. That it can be different tap sizes from 3/16-1 inch (5 mm-21 mm).

5. That my design takes the place of two different tools.

6. That it can also be called easy taps.
